(19) United States
(12) Patent Application Publication
(10) Pub. No.: US 2017/0371487 A1
(43) Pub. Date: Dec. 28, 2017

(54) FRAME-PHASE SYNCHRONIZATION IN FREQUENCY DIVISION MODULATED TOUCH SYSTEMS

(71) Applicant: Tactual Labs Co., New York, NY (US)

(72) Inventors: Daniel John Morelli, Georgetown, TX (US); Robert Joseph Alack, JR., Austin, TX (US); Kaan Duman, Leesburg, VA (US); Darren Laney Leigh, Round Hill, VA (US)

(73) Assignee: Tactual Labs Co., New York, NY (US)

(21) Appl. No.: 15/195,675

(22) Filed: Jun. 28, 2016

(51) Int. Cl. G06F 3/041; G06F 3/044

(52) U.S. Cl. CPC G06F 3/0418; G06F 3/044; G06F 2203/04108; G06F 2203/04103; G06F 2203/04112; G06F 2203/04104

(57) ABSTRACT

A system and method for performing frame-phase synchronization on received frames of signal on a touch detector. An apparatus and method for synchronizing frames with the phase of one or more simultaneously transmitted signals on a touch detector. One or more row conductors and one or more column conductors are arranged such that the path of the row conductor(s) cross the path of the column conductor(s). A signal emitter simultaneously initiates transmission of orthogonal signals on each of the rows at each of a plurality of intervals starting at a first time, the orthogonal signals having a known initial phase. A receiver starts receiving frames on the column at each of the intervals, starting at a later time. A signal processor determines a measure of the extent to which each of the orthogonal signals are present within the received frame—and thus, the extent to which they were transmitted across the touch detector. The determined measures may be reflected in a heat map reflective of the state of the touch detector, and comparison of successive heat maps (or measures) being reflective of touch or changes in touch.

### FIELD

The disclosed system and method relate in general to the field of user input, and in particular to performing frame-phase synchronization on one or more transmitted frequencies on a frequency division modulated touch detector.

### BRIEF DESCRIPTION OF THE DRAWINGS

The foregoing and other objects, features, and advantages of the disclosure will be apparent from the following more particular description of embodiments as illustrated in the accompanying drawings, in which reference characters refer to the same parts throughout the various views. The drawings are not necessarily to scale, emphasis instead being placed upon illustrating principles of the disclosed embodiments.

FIG. 1 provides a high level block diagram illustrating an embodiment of a low-latency touch sensor device.

FIG. 2 provides a functional block diagram illustrating an embodiment of frame-phase synchronization.

FIG. 3 provides a functional block diagram of an illustrative frequency division modulated touch detector.

### DETAILED DESCRIPTION

This application relates to user interfaces such as the fast multi-touch sensors and other interfaces disclosed in U.S. patent application Ser. No. 15/099,179 filed Apr. 14, 2016 entitled “Capacitive Sensor Patterns” and U.S. patent application Ser. No. 15/162,240 filed May 23, 2016 entitled “Transmitting and Receiving System and Method for Bidirectional Orthogonal Signaling Sensors.” The entire disclosures of those applications are incorporated herein by reference.

In various embodiments, the present disclosure is directed to systems and methods for designing and manufacturing capacitive touch sensors, and particular capacitive touch sensors having particular compositions or geometry.

Throughout this disclosure, the terms “touch”, “touches,” “contact,” “contacts” or other descriptors may be used to describe events or periods of time in which a user's finger, a stylus, an object or a body part is detected by the sensor. In some embodiments, these detections occur only when the user is in physical contact with a sensor, or a device in which it is embodied. In other embodiments, the sensor may be tuned to allow the detection of “touches” or “contacts” that are hovering a distance above the touch surface or otherwise separated from the touch sensitive device. Therefore, the use of language within this description that implies reliance upon sensed physical contact should not be taken to mean that the techniques described apply only to those embodiments; indeed, nearly all, if not all, of what is described herein would apply equally to “touch” and “hover” sensors. More generally, as used herein, the term “touch” refers to an act that can be detected by the types of sensors disclosed herein, thus, as used herein the term “hover” is but one type of “touch” in the sense that “touch” is intended herein. Other types of sensors can be utilized in connection with the embodiments disclosed herein, including a camera, a proximity sensor, an optical sensor, a turn-rate sensor, a gyroscope, a magnetometer, a thermal sensor, a pressure sensor, a force sensor, a capacitive touch sensor, a power-management integrated circuit reading, a keyboard, a mouse, a motion sensor, and the like.

As used herein, and especially within the claims, ordinal terms such as first and second are not intended, in and of themselves, to imply sequence, time or uniqueness, but rather, are used to distinguish one claimed construct from another. In some uses where the context dictates, these terms may imply that the first and second are unique. For example, where an event occurs at a first time, and another event occurs at a second time, there is no intended implication that the first time occurs before the second time. However, where the further limitation that the second time is after the first time is presented in the claim, the context would require reading the first time and the second time to be unique times. Similarly, where the context so dictates or permits, ordinal terms are intended to be broadly construed so that the two identified claim constructs can be of the same characteristic or of different characteristic. Thus, for example, a first and a second frequency, absent further limitation, could be the same frequency—e.g., the first frequency being 10 Mhz and the second frequency being 10 Mhz; or could be different frequencies—e.g., the first frequency being 10 Mhz and the second frequency being 11 Mhz. Context may dictate otherwise, for example, where a first and a second frequency are further limited to being orthogonal to each other, in which case, they could not be the same frequency.

The presently disclosed systems and methods provide for designing, manufacturing and using capacitive touch sensors, and particularly capacitive touch sensors that employ a multiplexing scheme based on orthogonal signaling such as but not limited to frequency-division multiplexing (FDM), code-division multiplexing (CDM), or a hybrid modulation technique that combines both FDM and CDM methods. References to frequency herein could also refer to other orthogonal signal bases. As such, this application incorporates by reference Applicants' prior U.S. patent application Ser. No. 13/841,436, filed on Mar. 15, 2013 entitled “Low-Latency Touch Sensitive Device” and U.S. patent application Ser. No. 14/069,609 filed on Nov. 1, 2013 entitled “Fast Multi-Touch Post Processing.” These applications contemplate capacitive FDM, CDM, or FDM/CDM hybrid touch sensors which may be used in connection with the presently disclosed sensors. In such sensors, touches are sensed when a signal from a row is coupled (increased) or decoupled (decreased) to a column and the result received on that column.

This disclosure will first describe the operation of fast multi-touch sensors to which the present systems and methods for design, manufacturing and use can be applied. Details of the presently disclosed system and method for performing frame-phase synchronization on a frequency division modulated touch detector are then described further below under the heading “Frame-Phase Synchronization.”

As used herein, the phrase “touch event” and the word “touch” when used as a noun include a near touch and a near touch event, or any other gesture that can be identified using a sensor. In accordance with an embodiment, touch events may be detected, processed and supplied to downstream computational processes with very low latency, e.g., on the order of ten milliseconds or less, or on the order of less than one millisecond.

In an embodiment, the disclosed fast multi-touch sensor utilizes a projected capacitive method that has been enhanced for high update rate and low latency measurements of touch events. The technique can use parallel hardware and higher frequency waveforms to gain the above advantages. Also disclosed are methods to make sensitive and robust measurements, which methods may be used on transparent display surfaces and which may permit economical manufacturing of products which employ the technique. In this regard, a “capacitive object” as used herein could be a finger, other part of the human body, a stylus, or any object to which the sensor is sensitive. The sensors and methods disclosed herein need not rely on capacitance. With respect to, e.g., the optical sensor, such embodiments utilize photon tunneling and leaking to sense a touch event, and a “capacitive object” as used herein includes any object, such as a stylus or finger, that that is compatible with such sensing. Similarly, “touch locations” and “touch sensitive device” as used herein do not require actual touching contact between a capacitive object and the disclosed sensor.

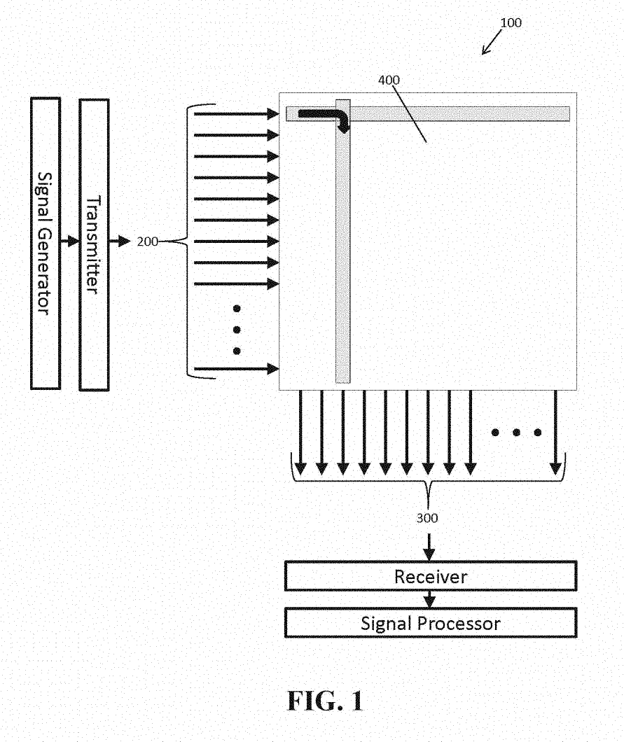

FIG. 1 illustrates certain principles of a fast multi-touch sensor 100 in accordance with an embodiment. At reference no. 200, a different signal is transmitted into each of the surface's rows. The signals are designed to be “orthogonal”, i.e., separable and distinguishable from each other. At reference no. 300, a receiver is attached to each column. The receiver is designed to receive any of the transmitted signals, or an arbitrary combination of them, with or without other signals and/or noise, and to individually determine a measure, e.g., a quantity for each of the orthogonal transmitted signals present on that column. The touch surface 400 of the sensor comprises a series of rows and columns (not all shown), along which the orthogonal signals can propagate. In an embodiment, the rows and columns are designed so that, when they are not subject to a touch event, a lower or negligible amount of signal is coupled between them, whereas, when they are subject to a touch event, a higher or non-negligible amount of signal is coupled between them. In an embodiment, the opposite could hold—having the lesser amount of signal represent a touch event, and the greater amount of signal represent a lack of touch. Because the touch sensor ultimately detects touch due to a change in the coupling, it is not of specific importance, except for reasons that may otherwise be apparent to a particular embodiment, whether the touch-related coupling causes an increase in amount of row signal present on the column or a decrease in the amount of row signal present on the column. As discussed above, the touch, or touch event does not require a physical touching, but rather an event that affects the level of coupled signal.

With continued reference to FIG. 1, in an embodiment, generally, the capacitive result of a touch event in the proximity of both a row and column may cause a non-negligible change in the amount of signal present on the row to be coupled to the column. More generally, touch events cause, and thus correspond to, the received signals on the columns. Because the signals on the rows are orthogonal, multiple row signals can be coupled to a column and distinguished by the receiver. Likewise, the signals on each row can be coupled to multiple columns. For each column coupled to a given row (and regardless of whether the coupling causes an increase or decrease in the row signal to be present on the column), the signals found on the column contain information that will indicate which rows are being touched simultaneously with that column. The quantity of each signal received is generally related to the amount of coupling between the column and the row carrying the corresponding signal, and thus, may indicate a distance of the touching object to the surface, an area of the surface covered by the touch and/or the pressure of the touch.

When a row and column are touched simultaneously, some of the signal that is present on the row is coupled into the corresponding column (the coupling may cause an increase or decrease of the row signal on the column). (As discussed above, the term touch or touched does not require actual physical contact, but rather, relative proximity.) Indeed, in various implementations of a touch device, physical contact with the rows and/or columns is unlikely as there may be a protective barrier between the rows and/or columns and the finger or other object of touch. Moreover, generally, the rows and columns themselves are not in touch with each other, but rather, placed in a proximity that allows an amount of signal to be coupled there-between, and that amount changes (positively or negatively) with touch. Generally, the row-column coupling results not from actual contact between them, nor by actual contact from the finger or other object of touch, but rather, by the capacitive effect of bringing the finger (or other object) into close proximity—which close proximity resulting in capacitive effect is referred to herein as touch.

The nature of the rows and columns is arbitrary and the particular orientation is irrelevant. Indeed, the terms row and column are not intended to refer to a square grid, but rather to a set of conductors upon which signal is transmitted (rows) and a set of conductors onto which signal may be coupled (columns). (The notion that signals are transmitted on rows and received on columns itself is arbitrary, and signals could as easily be transmitted on conductors arbitrarily designated columns and received on conductors arbitrarily named rows, or both could arbitrarily be named something else.) Further, it is not necessary that the rows and columns be in a grid. Other shapes are possible as long as a touch event will touch part of a “row” and part of a “column”, and cause some form of coupling. For example, the “rows” could be in concentric circles and the “columns” could be spokes radiating out from the center. And neither the “rows” nor the “columns” need to follow any geometric or spatial pattern, thus, for example, the keys on keyboard could be arbitrarily connected to form rows and columns (related or unrelated to their relative positions.) Moreover, it is not necessary for there to be only two types signal propagation channels: instead of rows and columns, in an embodiment, channels “A”, “B” and “C” may be provided, where signals transmitted on “A” could be received on “B” and “C”, or, in an embodiment, signals transmitted on “A” and “B” could be received on “C”. It is also possible that the signal propagation channels can alternate function, sometimes supporting transmitters and sometimes supporting receivers. It is also contemplated that the signal propagation channels can simultaneously support transmitters and receivers—provided that the signals transmitted are orthogonal, and thus separable, from the signals received. Three or more types of antenna conductors may be used rather than just “rows” and “columns.” Many alternative embodiments are possible and will be apparent to a person of skill in the art after considering this disclosure.

As noted above, in an embodiment the touch surface 400 comprises of a series of rows and columns, along which signals can propagate. As discussed above, the rows and columns are designed so that, when they are not being touched, one amount of signal is coupled between them, and when they are being touched, another amount of signal is coupled between them. The change in signal coupled between them may be generally proportional or inversely proportional (although not necessarily linearly proportional) to the touch such that touch is less of a yes-no question, and more of a gradation, permitting distinction between more touch (i.e., closer or firmer) and less touch (i.e., farther or softer)—and even no touch. Moreover, a different signal is transmitted into each of the rows. In an embodiment, each of these different signals are orthogonal (i.e., separable and distinguishable) from one another. When a row and column are touched simultaneously, signal that is present on the row is coupled (positively or negatively), causing more or less to appear in the corresponding column. The quantity of the signal that is coupled onto a column may be related to the proximity, pressure or area of touch.

A receiver 300 is attached to each column. The receiver is designed to receive the signals present on the columns, including any of the orthogonal signals, or an arbitrary combination of the orthogonal signals, and any noise or other signals present. Generally, the receiver is designed to receive a frame of signals present on the columns, and to identify the columns providing signal. In an embodiment, the receiver (or a signal processor associated with the receiver data) may determine a measure associated with the quantity of each of the orthogonal transmitted signals present on that column during the time the frame of signals was captured. In this manner, in addition to identifying the rows in touch with each column, the receiver can provide additional (e.g., qualitative) information concerning the touch. In general, touch events may correspond (or inversely correspond) to the received signals on the columns. For each column, the different signals received thereon indicate which of the corresponding rows is being touched simultaneously with that column. In an embodiment, the amount of coupling between the corresponding row and column may indicate e.g., the area of the surface covered by the touch, the pressure of the touch, etc. In an embodiment, a change in coupling over time between the corresponding row and column indicates a change in touch at the intersection of the two.

### Simple Sinusoid Embodiment

In an embodiment, the orthogonal signals being transmitted onto the rows may be unmodulated sinusoids, each having a different frequency, the frequencies being chosen so that they can be distinguished from each other in the receiver. In an embodiment, frequencies are selected to provide sufficient spacing between them such that they can be more easily distinguished from each other in the receiver. In an embodiment, frequencies are selected such that no simple harmonic relationships exist between the selected frequencies. The lack of simple harmonic relationships may mitigate non-linear artifacts that can cause one signal to mimic another.

Generally, a “comb” of frequencies, where the spacing between adjacent frequencies is constant, and the highest frequency is less than twice the lowest, will meet these criteria if the spacing between frequencies, Δf, is at least the reciprocal of the measurement period τ. For example, if it is desired to measure a combination of signals (from a column, for example) to determine which row signals are present once per millisecond (τ), then the frequency spacing (Δf) must be greater than one kilohertz (i.e., Δf>1/τ). According to this calculation, in an example case with only ten rows, one could use the following frequencies:
Row 1: 5.000 MHz Row 6: 5.005 MHz
Row 2: 5.001 MHz Row 7: 5.006 MHz
Row 3: 5.002 MHz Row 8: 5.007 MHz
Row 4: 5.003 MHz Row 9: 5.008 MHz
Row 5: 5.004 MHz Row 10: 5.009 MHz

It will be apparent to one of skill in the art that frequency spacing may be substantially greater than this minimum to permit robust design. As an example, a 20 cm by 20 cm touch surface with 0.5 cm row/column spacing would require forty rows and forty columns and necessitate sinusoids at forty different frequencies. While a once per millisecond analysis rate would require only 1 KHz spacing, an arbitrarily larger spacing is utilized for a more robust implementation. In an embodiment, the arbitrarily larger spacing is subject to the constraint that the maximum frequency should not be more than twice the lowest (i.e., fₘₐₓ<2(fₘᵢₙ)). Thus, in this example, a frequency spacing of 100 kHz with the lowest frequency set at 5 MHz may be used, yielding a frequency list of 5.0 MHz, 5.1 MHz, 5.2 MHz, etc. up to 8.9 MHz.

In an embodiment, each of the sinusoids on the list may be generated by a signal generator and transmitted on a separate row by a signal emitter or transmitter. To identify the rows and columns that are being simultaneously touched, a receiver receives any signals present on the columns and a signal processor analyzes the signal to determine which, if any, frequencies on the list appear. In an embodiment, the identification can be supported with a frequency analysis technique (e.g., Fourier transform), or by using a filter bank. In an embodiment, the receiver receives a frame of column signals, which frame is processed through an FFT, and thus, a measure is determined for each frequency. In an embodiment, the FFT provides an in-phase and quadrature measure for each frequency, for each frame.

In an embodiment, from each column's signal, the receiver/signal processor can determine a value (and potentially an in-phase and quadrature value) for each frequency from the list of frequencies found in the signal on that column. In an embodiment, where the value of a frequency is greater or lower than some threshold, or changes from the prior value, the signal processor identifies there being a touch event between the column and the row corresponding to that frequency. In an embodiment, signal strength information, which may correspond to various physical phenomena including the distance of the touch from the row/column intersection, the size of the touch object, the pressure with which the object is pressing down, the fraction of row/column intersection that is being touched, etc. may be used as an aid to localize the area of the touch event. In an embodiment, the determined values are not self-determinative of touch, but rather are further processed along with other values to determine touch events.

Once values for each of the orthogonal frequencies have been determined for at least two frequencies (corresponding to rows) or for at least two columns, a two-dimensional map can be created, with the value being used as, or proportional/inversely proportional to, a value of the map at that row/column intersection. In an embodiment, values are determined at multiple row/column intersections on a touch surface to produce a map for the touch surface or region. In an embodiment, values are determined for every row/column intersection on a touch surface, or in a region of a touch surface, to produce a map for the touch surface or region. In an embodiment, the signals' values are calculated for each frequency on each column. Once signal values are calculated a two-dimensional map may be created. In an embodiment, the signal value is the value of the map at that row/column intersection. In an embodiment, the signal value is processed to reduce noise before being used as the value of the map at that row/column intersection. In an embodiment, another value proportional, inversely proportional or otherwise related to the signal value (either after being processed to reduce noise) is employed as the value of the map at that row/column intersection. In an embodiment, due to physical differences in the touch surface at different frequencies, the signal values are normalized for a given touch or calibrated. Similarly, in an embodiment, due to physical differences across the touch surface or between the intersections, the signal values need to be normalized for a given touch or calibrated.

In an embodiment, the two-dimensional map data may be thresholded to better identify, determine or isolate touch events. In an embodiment, the two-dimensional map data may be used to infer information about the shape, orientation, etc. of the object touching the surface.

In an embodiment, such analysis and any touch processing described herein is performed on a touch sensor's discrete touch controller. In another embodiment, such analysis and touch processing could be performed on other computer system components such as but not limited to one or more ASIC, MCU, FPGA, CPU, GPU, SoC, DSP or dedicated circuit. The term “hardware processor” as used herein means any of the above devices or any other device which performs computational functions.

Returning to the discussion of the signals being transmitted on the rows, a sinusoid is not the only orthogonal signal that can be used in the configuration described above. Indeed, as discussed above, any set of signals that can be distinguished from each other will work. Nonetheless, sinusoids may have some advantageous properties that may permit simpler engineering and more cost efficient manufacture of devices which use this technique. For example, sinusoids have a very narrow frequency profile (by definition), and need not extend down to low frequencies, near DC. Moreover, sinusoids can be relatively unaffected by 1/f noise, which noise could affect broader signals that extend to lower frequencies.

In an embodiment, sinusoids may be detected by a filter bank. In an embodiment, sinusoids may be detected by frequency analysis techniques (e.g., Fourier transform). Frequency analysis techniques may be implemented in a relatively efficient manner and may tend to have good dynamic range characteristics, allowing them to detect and distinguish between a large number of simultaneous sinusoids. In broad signal processing terms, the receiver's decoding of multiple sinusoids may be thought of as a form of frequency-division multiplexing. In an embodiment, other modulation techniques such as time-division and code-division multiplexing could also be used. Time division multiplexing has good dynamic range characteristics, but typically requires that a finite time be expended transmitting into (or analyzing received signals from) the touch surface. Code division multiplexing has the same simultaneous nature as frequency-division multiplexing, but may encounter dynamic range problems and may not distinguish as easily between multiple simultaneous signals.

### Modulated Sinusoid Embodiment

In an embodiment, a modulated sinusoid may be used in lieu of, in combination with and/or as an enhancement of, the sinusoid embodiment described above. The use of unmodulated sinusoids may cause radiofrequency interference to other devices near the touch surface, and thus, a device employing them might encounter problems passing regulatory testing (e.g., FCC, CE). In addition, the use of unmodulated sinusoids may be susceptible to interference from other sinusoids in the environment, whether from deliberate transmitters or from other interfering devices (perhaps even another identical touch surface). In an embodiment, such interference may cause false or degraded touch measurements in the described device.

In an embodiment, to avoid interference, the sinusoids may be modulated or “stirred” prior to being transmitted by the transmitter in a manner that the signals can be demodulated (“unstirred”) once they reach the receiver. In an embodiment, an invertible transformation (or nearly invertible transformation) may be used to modulate the signals such that the transformation can be compensated for and the signals substantially restored once they reach the receiver. As will also be apparent to one of skill in the art, signals emitted or received using a modulation technique in a touch device as described herein will be less correlated with other things, and thus, act more like mere noise, rather than appearing to be similar to, and/or being subject to interference from, other signals present in the environment.

In an embodiment, a modulation technique utilized will cause the transmitted data to appear fairly random or, at least, unusual in the environment of the device operation. Two modulation schemes are discussed below: Frequency Modulation and Direct Sequence Spread Spectrum Modulation.

### Frequency Modulation

Frequency modulation of the entire set of sinusoids keeps them from appearing at the same frequencies by “smearing them out.” Because regulatory testing is generally concerned with fixed frequencies, transmitted sinusoids that are frequency modulated will appear at lower amplitudes, and thus be less likely to be a concern. Because the receiver will “un-smear” any sinusoid input to it, in an equal and opposite fashion, the deliberately modulated, transmitted sinusoids can be demodulated and will thereafter appear substantially as they did prior to modulation. Any fixed frequency sinusoids that enter (e.g., interfere) from the environment, however, will be “smeared” by the “unsmearing” operation, and thus, will have a reduced or an eliminated effect on the intended signal. Accordingly, interference that might otherwise be caused to the sensor is lessened by employing frequency modulation, e.g., to a comb of frequencies that, in an embodiment, are used in the touch sensor.

In an embodiment, the entire set of sinusoids may be frequency modulated by generating them all from a single reference frequency that is, itself, modulated. For example, a set of sinusoids with 100 kHz spacing can be generated by multiplying the same 100 kHz reference frequency by different integers. In an embodiment this technique can be accomplished using phase-locked loops. To generate the first 5.0 MHz sinusoid, one could multiply the reference by 50, to generate the 5.1 MHz sinusoid, one could multiply the reference by 51, and so forth. The receiver can use the same modulated reference to perform the detection and demodulation functions.

### Direct Sequence Spread Spectrum Modulation

In an embodiment, the sinusoids may be modulated by periodically inverting them on a pseudo-random (or even truly random) schedule known to both the transmitter and receiver. Thus, in an embodiment, before each sinusoid is transmitted to its corresponding row, it is passed through a selectable inverter circuit, the output of which is the input signal multiplied by +1 or −1 depending on the state of an “invert selection” input. In an embodiment, all of these “invert selection” inputs are driven from the same signal, so that the sinusoids for each row are all multiplied by either +1 or −1 at the same time. In an embodiment, the signal that drives the “invert selection” input may be a pseudorandom function that is independent of any signals or functions that might be present in the environment. The pseudorandom inversion of the sinusoids spreads them out in frequency, causing them to appear like random noise so that they interfere negligibly with any devices with which they might come in contact.

On the receiver side, the signals from the columns may be passed through selectable inverter circuits that are driven by the same pseudorandom signal as the ones on the rows. The result is that, even though the transmitted signals have been spread in frequency, they are despread before the receiver because they have been ben multiplied by either +1 or −1 twice, leaving them in, or returning them to, their unmodified state. Applying direct sequence spread spectrum modulation may spread out any interfering signals present on the columns so that they act only as noise and do not mimic any of the set of intentional sinusoids.

In an embodiment, selectable inverters can be created from a small number of simple components and/or can be implemented in transistors in a VLSI process.

Because many modulation techniques are independent of each other, in an embodiment, multiple modulation techniques could be employed at the same time, e.g., frequency modulation and direct sequence spread spectrum modulation of the sinusoid set. Although potentially more complicated to implement, such multiple modulated implementation may achieve better interference resistance.

Because it would be extremely rare to encounter a particular pseudo random modulation in the environment, it is likely that the multi-touch sensors described herein would not require a truly random modulation schedule. One exception may be where more than one touch surface with the same implementation is being touched by the same person. In such a case, it may be possible for the surfaces to interfere with each other, even if they use very complicated pseudo random schedules. Thus, in an embodiment, care is taken to design pseudo random schedules that are unlikely to conflict. In an embodiment, some true randomness may be introduced into the modulation schedule. In an embodiment, randomness is introduced by seeding the pseudo random generator from a truly random source and ensuring that it has a sufficiently long output duration (before it repeats). Such an embodiment makes it highly unlikely that two touch surfaces will ever be using the same portion of the sequence at the same time. In an embodiment, randomness is introduced by exclusive or'ing (XOR) the pseudo random sequence with a truly random sequence. The XOR function combines the entropy of its inputs, so that the entropy of its output is never less than either input.

### A Low-Cost Implementation Embodiment

Touch surfaces using the previously described techniques may have a relatively high cost associated with generating and detecting sinusoids compared to other methods. Below are discussed methods of generating and detecting sinusoids that may be more cost-effective and/or be more suitable for mass production.

### Sinusoid Detection

In an embodiment, sinusoids may be detected in a receiver using a complete radio receiver with a Fourier Transform detection scheme. Such detection may require digitizing a high-speed RF waveform and performing digital signal processing thereupon. Separate digitization and signal processing may be implemented for every column of the surface; this permits the signal processor to discover which of the row signals are in touch with that column. In the above-noted example, having a touch surface with forty rows and forty columns, would require forty copies of this signal chain. Today, digitization and digital signal processing are relatively expensive operations, in terms of hardware, cost, and power. It would be useful to utilize a more cost-effective method of detecting sinusoids, especially one that could be easily replicated and requires very little power.

In an embodiment, sinusoids may be detected using a filter bank. A filter bank comprises an array of bandpass filters that can take an input signal and break it up into the frequency components associated with each filter. The Discrete Fourier Transform (DFT, of which the FFT is an efficient implementation) is a form of a filter bank with evenly-spaced bandpass filters that may be used for frequency analysis. DFTs may be implemented digitally, but the digitization step may be expensive. It is possible to implement a filter bank out of individual filters, such as passive LC (inductor and capacitor) or RC active filters. Inductors are difficult to implement well on VLSI processes, and discrete inductors are large and expensive, so it may not be cost effective to use inductors in the filter bank.

At lower frequencies (about 10 MHz and below), it is possible to build banks of RC active filters on VLSI. Such active filters may perform well, but may also take up a lot of die space and require more power than is desirable.

At higher frequencies, it is possible to build filter banks with surface acoustic wave (SAW) filter techniques. These allow nearly arbitrary FIR filter geometries. SAW filter techniques require piezoelectric materials which are more expensive than straight CMOS VLSI. Moreover, SAW filter techniques may not allow enough simultaneous taps to integrate sufficiently many filters into a single package, thereby raising the manufacturing cost.

In an embodiment, sinusoids may be detected using an analog filter bank implemented with switched capacitor techniques on standard CMOS VLSI processes that employs an FFT-like “butterfly” topology. The die area required for such an implementation is typically a function of the square of the number of channels, meaning that a 64-channel filter bank using the same technology would require only 1/256th of the die area of the 1024-channel version. In an embodiment, the complete receive system for the low-latency touch sensor is implemented on a plurality of VLSI dies, including an appropriate set of filter banks and the appropriate amplifiers, switches, energy detectors, etc. In an embodiment, the complete receive system for the low-latency touch sensor is implemented on a single VLSI die, including an appropriate set of filter banks and the appropriate amplifiers, switches, energy detectors, etc. In an embodiment, the complete receive system for the low-latency touch sensor is implemented on a single VLSI die containing n instances of an n-channel filter bank, and leaving room for the appropriate amplifiers, switches, energy detectors, etc.

### Sinusoid Generation

Generating the transmit signals (e.g., sinusoids) in a low-latency touch sensor is generally less complex than detection, principally because each row requires the generation of a single signal while the column receivers have to detect and distinguish between many signals. In an embodiment, sinusoids can be generated with a series of phase-locked loops (PLLs), each of which multiply a common reference frequency by a different multiple.

In an embodiment, the low-latency touch sensor design does not require that the transmitted sinusoids are of very high quality, but rather, accommodates transmitted sinusoids that have more phase noise, frequency variation (over time, temperature, etc.), harmonic distortion and other imperfections than may usually be allowable or desirable in radio circuits. In an embodiment, the large number of frequencies may be generated by digital means and then employ a relatively coarse analog-to-digital conversion process. As discussed above, in an embodiment, the generated row frequencies should have no simple harmonic relationships with each other, any non-linearities in the described generation process should not cause one signal in the set to “alias” or mimic another.

In an embodiment, a frequency comb may be generated by having a train of narrow pulses filtered by a filter bank, each filter in the bank outputting the signals for transmission on a row. The frequency “comb” is produced by a filter bank that may be identical to a filter bank that can be used by the receiver. As an example, in an embodiment, a 10 nanosecond pulse repeated at a rate of 100 kHz is passed into the filter bank that is designed to separate a comb of frequency components starting at 5 MHz, and separated by 100 kHz. The pulse train as defined would have frequency components from 100 kHz through the tens of MHz, and thus, would have a signal for every row in the transmitter. Thus, if the pulse train were passed through an identical filter bank to the one described above to detect sinusoids in the received column signals, then the filter bank outputs will each contain a single sinusoid that can be transmitted onto a row.

### Transparent Display Surface

It may be desirable that the touch surface be integrated with a computer display so that a person can interact with computer-generated graphics and imagery. While front projection can be used with opaque touch surfaces and rear projection can be used with translucent ones, modern flat panel displays (LCD, plasma, OLED, etc.) generally require that the touch surface be transparent. In an embodiment, the present technique's rows and columns, which allow signals to propagate along them, need to be conductive to those signals. In an embodiment, the present technique's rows and columns, which allow radio frequency signals to propagate along them, need to be electrically conductive.

If the rows and columns are insufficiently conductive, the resistance per unit length along the row/column will combine with the capacitance per unit length to form a low-pass filter: any high-frequency signals applied at one end will be substantially attenuated as they propagate along the poor conductor.

Visually transparent conductors are commercially available (e.g., indium-tin-oxide or ITO), but the tradeoff between transparency and conductivity is problematic at the frequencies that may be desirable for some embodiments of the low-latency touch sensor described herein: if the ITO were thick enough to support certain desirable frequencies over certain lengths, it may be insufficiently transparent for some applications. In an embodiment, the rows and/or columns may be formed entirely, or at least partially, from graphene and/or carbon nanotubes, which are both highly conductive and optically transparent.

In an embodiment, the rows and/or columns may be formed from one or more fine wires that block a negligible amount of the display behind them. In an embodiment, the fine wires are too small to see, or at least too small to present a visual impediment when viewing a display behind it. In an embodiment, fine silver wires patterned onto transparent glass or plastic can be used to make up the rows and/or columns. Such fine wires need to have sufficient cross section to create a good conductor along the row/column, but it is desirable (for rear displays) that such wires are small enough and diffuse enough to block as little of the underlying display as appropriate for the application. In an embodiment, the fine wire size is selected on the basis of the pixels size and/or pitch of the underlying display.

As an example, the new Apple Retina displays comprises about 300 pixels per inch, which yields a pixel size of about 80 microns on a side. In an embodiment, a 20 micron diameter silver wire 20 centimeters long (the length of an iPad display), which has a resistance of about 10 ohms, is used as a row and/or column and/or as part of a row and/or column in a low-latency touch sensor as described herein. Such 20 micron diameter silver wire, however, if stretched across a retina display, may block up to 25% of an entire line of pixels. Accordingly, in an embodiment, multiple thinner diameter silver wires may be employed as a column or row, which can maintain an appropriate resistance, and provide acceptable response with respect to radiofrequency skin depth issues. Such multiple thinner diameter silver wires can be laid in a pattern that is not straight, but rather, somewhat irregular. A random or irregular pattern of thinner wires is likely to be less visually intrusive. In an embodiment, a mesh of thin wires is used; the use of a mesh will improve robustness, including against manufacturing flaws in patterning. In an embodiment, single thinner diameter wires may be employed as a column or row, provided that the thinner wire is sufficiently conductive to maintain an appropriate level resistance, and acceptable response with respect to radiofrequency skin depth issues.

After the signal strengths from each row in each column have been calculated using, for example, the procedures described above, post-processing is performed to convert the resulting 2-D “heat map,” also referred to as a “matrix,” into usable touch events. In an embodiment, such post processing includes at least some of the following four procedures: field flattening, touch point detection, interpolation and touch point matching between frames, as more specifically disclosed in U.S. patent application Ser. No. 14/881,873, filed Oct. 13, 2015, entitled “Fast Multi-Touch Post Processing.” The entire disclosures of those applications are incorporated herein by reference. The field flattening procedure therein disclosed subtracts an offset level to remove crosstalk between rows and columns, and compensates for differences in amplitude between particular row/column combinations due to attenuation. The touch point detection procedure therein disclosed computes the coarse touch points by finding local maxima in the flattened signal. The interpolation procedure therein disclosed computes the fine touch points by fitting data associated with the coarse touch points to a paraboloid. The frame matching procedure therein disclosed matches the calculated touch points to each other across frames.

In U.S. patent application Ser. No. 14/216,791, filed Mar. 17, 2014, entitled “Fast Multi-Touch Noise Reduction” and U.S. patent application Ser. No. 14/216,948, entitled “Fast Multi-Touch Stylus and Sensor,” both filed on Mar. 17, 2014, methods and systems are provided to overcome certain conditions in which noise produces interference with, or phantom touches in, the Fast Multi-Touch (FMT) sensor. The entire disclosures of these applications are incorporated herein by reference. In an embodiment, unique signals may be transmitted on all rows and columns. In an embodiment, unique signals may be transmitted on each row in one or more subsets of rows. In an embodiment, unique signals may be transmitted on each column in one or more subsets of columns. In an embodiment, all rows and columns are configured to detect the unique signals. In an embodiment, each row in one or more subsets of rows is configured to detect the unique signals. In an embodiment, each column in one or more subsets of columns is configured to detect the unique signals.

As disclosed in U.S. patent application Ser. No. 14/603,104, filed Jan. 22, 2015, entitled “Dynamic Assignment of Possible Channels in a Touch Sensor,” a system and method enables a touch sensor to reduce or eliminate such false or noisy readings and maintain a high signal-to-noise ratio, even if it is proximate to interfering electromagnetic noise from other computer system components or unwanted external signals. This method can also be used to dynamically reconfigure the signal modulation scheme governing select portions or the entire surface-area of a touch sensor at a given point in time in order to lower the sensor's total power consumption, while still optimizing the sensor's overall performance in terms of parallelism, latency, sample-rate, dynamic range, sensing granularity, etc. The entire disclosure of the application is incorporated herein by reference.

Frame-Phase Synchronization

In the past, signal emitters were not correlated with the receivers on the touch detector. Further, all of the emitted frequencies would drive the panel on the touch detector, and the receiver could start collecting emitted signals and data at any time. Thus, the emitted signals and data collected were not correlated with the transmission of the emitted signals.

The methods and systems provided herein are used to overcome certain conditions in which noise or other artifacts produce interference with, jitter in, or phantom touches on, the FMT sensor. FMT method may be implemented by driving multiple frequencies simultaneously. The receiver then processes a combined waveform of that may have varying degrees of the multiple frequencies to calculate values for each of the individual driving frequencies e.g., with the use of FFT. Frame-to-frame variation in phase offsets of the driving signals, and thus in the signal supplied to the FFT may create a difference in the resulting calculated values, thereby affecting the accuracy of the FMT sensor.

The present embodiments provide methods and systems for reducing or eliminating undesirable results by mitigating the variation in the calculated values for each of the individual frequencies when the touch device is in the same state of touch. By way of example, in an embodiment, prior to beginning each frame, the signal can be synchronized by resetting all of the emitted signal frequencies to a predetermined, or known, initial phase. Such resetting may be repeated prior to acquisition of all subsequent frames. In an embodiment, the receiver can be set (or triggered) to capture a frame at successive periods when the emitted signal frequencies are known to be in a particular phase and phase relationship. Because the emitted signal frequencies have a beat period, in an embodiment, a frame period (i.e., the reciprocal of the frame frequency) is selected as a multiple of the beat period, thus ensuring that the samples from each frame will be in the same phase and phase relationship as the previous frame.

Several approaches are illustrated below to mitigate the variation in calculated values for the individual frequencies. Generally, each of the approaches endeavors to make the repeating capture operations, which to exploit the claimed touch detector are captured one after another (but not necessarily one immediately after another), capture frames of data that are identical in phase. In other words, the captured data is frame-phase synchronized between frames. In various embodiments, this can be accomplished by reinitiating transmission of the signal, at a known initial phase, at a known time before capture. As used herein, “known initial phase” means that the initial phase is predetermined or the phase is generated at the time of the initial transmission and it becomes known in subsequent frames. In various embodiments, this can be accomplished by continuously transmitting, but determining when frames will be frame-phase synchronized and delaying capture until the frame-phase synchronization. The several embodiments below illustrate a variety of systems and methods for frame-phase synchronization, but are not intended to limit the scope of the claims. Other systems and methods of frame-phase synchronization to improve touch data will become apparent to persons of skill in the art in view of this disclosure, and are thus included within the scope of this disclosure.

A method for synchronizing one or more simultaneously transmitted signals on a touch detector may involve one or more of the processing operations as described below. In an embodiment, the touch detector comprises a matrix comprising “N” rows and “M” columns of conductive material, the touch detector is arranged such that the paths of each of the “N” rows in the matrix crosses the path of each of the “M” columns in the matrix. The touch detector comprises a receiver associated with each of the “M” columns and at least one signal processor. The transmission of signals is initiated on each of the rows of the matrix. In an embodiment, transmission is achieved by supplying signal-related values to a DAC that is connected to the rows. The transmitted signals are frequency-orthogonal to each other, and the transmitted signals each have a specific initial phase. At a predetermined time after the signal transmission is initiated, a frame of data is captured for each of the columns of the matrix, the frames of data captured represents the signals present on the corresponding column during the frame capture time. In an embodiment, the frame of data is captured by sampling the columns using an ADC. These steps of initiating transmission, waiting and capturing frames is repeated, providing map of data that show changes in time associated with touch, but mitigating phase-related artifacts that could show up as noise or changing touch data.

A basic one-row, one-column touch detector apparatus is described to illustrate some of the principles discussed above. A row conductor and a column conductor are arranged such that the path of the row conductor crosses the path of the column conductor. A clock having a predetermined periodicity is provided. A signal emitter is adapted to initiate transmission of a signal at each of a plurality of intervals on the clock starting at a first time. Each time the transmission of the signal is initiated, the signal has the same initial phase as that signal had when transmissions of that signal was previously initiated. A receiver is adapted to start receiving a frame of data on the column at each of the plurality of intervals starting at a second, later time. And a signal processor is adapted to determine one of a range of measures of the signal present within the received frame, the one measure being reflective of touch.

The following illustrative embodiment discloses a touch detector apparatus having multiple rows and/or columns. A matrix of “N” rows and “M” columns of conductive material is arranged so that the paths of each of the rows in the matrix crosses the path of each of the columns. The illustrative touch detector also has a clock having a predetermined periodicity. Signal emitters are used to transmit unique signals on to each of the rows. The transmission is initiated at each of a plurality of intervals on the clock starting at a first time. In an embodiment, each of the transmitted signals is orthogonal to each of the other transmitted signals. In this illustrative embodiment, each of the transmitted signals has a known or predetermined initial phase—namely a phase that is the same each time its transmission is initiated. A receiver, receives a frame on each of the columns at each interval starting at a later time, that is, a time after transmission is initiated. The delay between transmission initiation and receiving allows signal propagation to normalize in the matrix, overcoming e.g., inertia. A signal processor is used to determine one of a range of measures for each of the transmitted signals, reflecting a value for presence of the transmitted signal within the received frame. In an embodiment, the signal processor and the receiver may be part of the same component. In another embodiment, the signal processor and the receiver are not part of the same component.

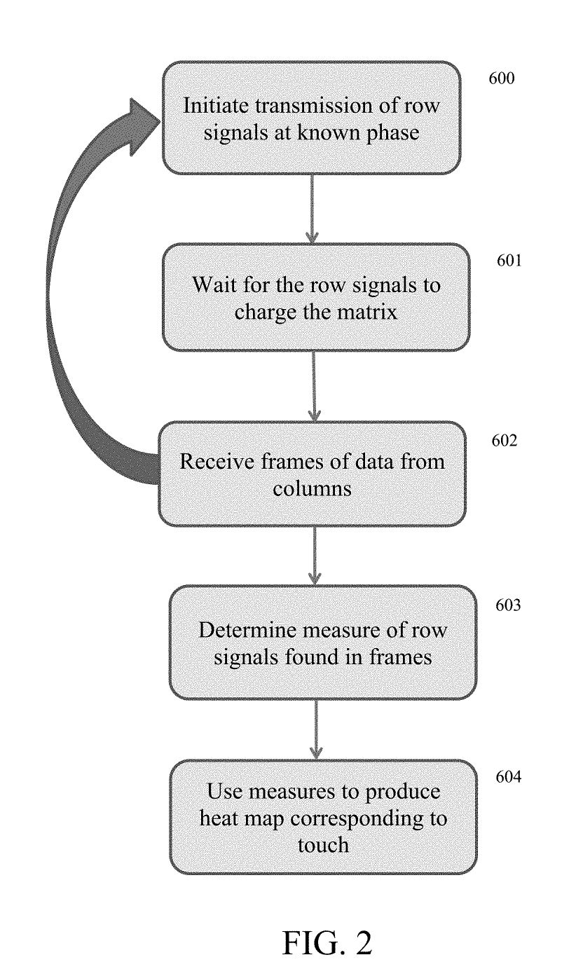

An illustrative embodiment of a method for determining measurements related to touch on a touch detector is also provided and shown in FIG. 2. In this method, a touch detector has a matrix comprising “N” rows and “M” columns of conductive material. The touch detector is arranged such that the paths of each of the “N” rows in the matrix cross the paths of each of the “M” columns in the matrix. The touch detector further having a receiver associated with at least one of the “M” columns, and at least one signal processor. The method including repeatedly: (i) initiating a transmission of a row signals at a known phase 600; (ii) waiting for the row signals to normalize in the matrix (e.g., to charge the matrix) 601; and (iii) receiving frames of data from columns 602. A measure of row signals found in the frames may be determined as shown in step 603. In an embodiment, an amount of row signal found on a column may be determined using an FFT function on the frame. In an embodiment, the FFT function will include both in-phase and quadrature components representing an amount of row signal. While noise and other artifacts may also be found on the column, touch from a touch detector is intended to be the predominant cause of the FFT measure. The measures may be used to produce a heat map corresponding to touch as shown in step 604.

Another illustrative method for determining measurements related to touch on a touch detector comprising a matrix of rows and columns of conductive material. The illustrative touch detector comprises a receiver associated with at least one of the columns. The method consists of repeatedly: (i) initiating a transmission of signals, each of the signals being transmitted on respective ones of the rows of the matrix, each of the signals being frequency-orthogonal to each of the other signals, and each of the signals being at a known initial phase; (ii) waiting a predetermined period of time after initiating the transmission, the predetermined period of time being at least sufficient for the signals to charge the matrix; and (iii) receiving on the receiver a frame of signals present on each of the columns of the matrix during a second predetermined period of time, the step of receiving beginning immediately after the predetermined period of time. The known initial phase for each of the signals may be predetermined, or if not predetermined, may be repeated as the method is repeatedly carried out, and may be the same as, or differ from the known initial phase of each other of the signals. In this way, each frame captured should have similar alignment of the phase of each respective signal. Once the capture is complete, the frames may be processed to determine a measure of the frequency-orthogonal signals present on the columns when it was captured. In an embodiment, the measure may be made by taking an FFT of the frame. Changes in the FFT values from one frame to the next are reflective of touch.

Another illustrative embodiment of an apparatus for measuring a level of a transmitted signal on a touch detector is also described using a touch detector having a first and second row conductor and a column conductor, arranged such that the path of each of the first and second row conductors cross the path of the column conductor. Signal emitters are adapted to transmit orthogonal signals on row conductors, respectively. A receiver receives a frame on the column at an interval related to the beat frequency of the orthogonal signals. A signal processor may be used to determine a measure of each of the signals present within the received frame—and thus, the capacitive response of the touch detector. In an embodiment, the signal processor and the receiver are part of the same component. In another embodiment, the signal processor and the receiver are not part of the same component. In an embodiment, the interval is a multiple of the beat frequency of the orthogonal signals.

Yet another illustrative apparatus for measuring a level of a plurality of orthogonal signals in a touch detector is also described using a touch detector having a matrix comprising rows and columns of conductive material, arranged such that the path of the matrix of rows and columns cross. A plurality of signal emitters each adapted to transmit one of a plurality of orthogonal signals onto a row of the matrix, each of the plurality of orthogonal signals being orthogonal to each of the other of the plurality of orthogonal signals, and the plurality of orthogonal signals having a beat frequency. The beat frequency has a periodic beat. A receiver starts receiving a frame on one of the columns of the matrix at a time related to the periodic beat of the beat frequency. A signal processor adapted to determine a measure of each of the plurality of orthogonal signals present within the received frame. In an embodiment, the signal processor and the receiver are part of the same component. In an embodiment, the signal processor and the receiver are not part of the same component. In an embodiment, the receiver receives a frame, periodically, at an interval related to the beat frequency of the plurality of orthogonal signals.

A further illustrative apparatus for measuring a level of a transmitted signal on a touch detector includes a first row conductor, and a first column conductor, arranged such that the path of the first row conductor crosses the path of the first column conductor. A clock having a predetermined periodicity. A first signal emitter adapted to initiate a plurality of temporally separate transmissions of a signal, each transmission of a signal starting at a time according to the clock, and the signal having a known initial phase. A receiver, adapted to receive a frame from a column, the frame comprising at least a portion of one of the plurality of temporally separate transmissions. The receiver adapted to start receiving the frame from the column at a later time according to the clock, the later time on the clock being after the corresponding transmission starting time. A signal processor adapted to determine a measure of the first signal present within each received frame. In an embodiment, this measure may be made by an FFT of the frame for the column conductor. In an embodiment, the measure may include both in-phase and quadrature components. In an embodiment, the signal processor and the receiver are part of the same component. In another embodiment, the signal processor and the receiver are not part of the same component.

Yet a further illustrative apparatus for measuring a level of transmitted signals on a touch detector includes a matrix comprising rows and columns arranged such that the path of each of the rows crosses the path of each of the columns. A clock having a predetermined periodicity. Signal emitters adapted to initiate a plurality of transmissions at different times. Each of the plurality of transmissions starting at a different time according to the clock. Each of the plurality of transmissions comprising a plurality of orthogonal signals. Each of the signal emitters transmitting a unique one of the plurality of orthogonal signals on a unique one of the rows during each of the plurality of transmissions occurring at different times. Each of the plurality of orthogonal signals has the same initial phase. A receiver adapted to receive a frame from each of the columns, each of the frames comprising at least a portion of one of the plurality of transmissions, and adapted to start receiving the frame from the column at a later time according to the clock. This later time on the clock being after the corresponding transmission starting time. And a signal processor adapted to determine a measure of each of the plurality of orthogonal signals present within each of the received frames. In an embodiment, the measures may be made by an FFT of the frame for the columns. In an embodiment, the measures may include both in-phase and quadrature components. In an embodiment, the signal processor and the receiver are part of the same component. In another embodiment, the signal processor and the receiver are not part of the same component.

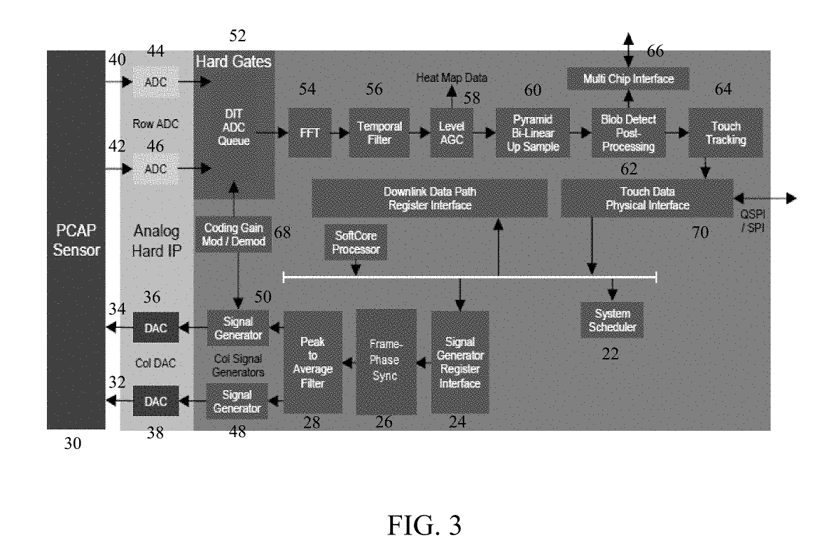

FIG. 3 provides a functional block diagram of an illustrative frequency division modulated touch detector, showing, among other things, an implementation of frame-phase synchronization within such a touch detector. A projected capacitive (PCAP) sensor 30 is shown; transmitted signals are transmitted to the rows 32, 34 of the PCAP sensor 30 via digital-to-analog converters (DAC) 36, 38 and time domain received signals are sampled from the columns 40, 42 by analog-to-digital converters (ADC) 44, 46. The transmitted signals are time domain signals generated by signal generators 48, 50 which is operatively connected to the DAC 36, 38. A Signal Generator Register Interface block 24 operatively connected to the System Scheduler 22, is responsible for initiating transmission of the time domain signals based on a schedule. Signal Generator Register Interface block 24 communicates with Frame-Phase Sync block 26, which causes Peak to Average Filter block 28 to feed Signal Generator blocks 48, 50 with data necessary to cause the signal generation.

Changes in the received signals are reflective of touch at the PCAP sensor 30, noise and/or other influences. The time domain received signals are queued in hard gates 52, before they are converted into the frequency domain by FFT block 54. A Coding Gain Modulator/Demodulator block provides bidirectional communications between the Signal Generator blocks 48, 50 and hard gates 52. A temporal filter block 56 and level automatic gain control (AGC) block 58 are applied to the FFT block 54 output. The AGC block 58 output is used to prove heat map data and is fed to UpSample block 60. UpSample block 60 interpolates the heat map to produce a larger map in an effort to improve accuracy of Blob Detection block 62. In an embodiment, up sampling can be performed using a bi-linear interpolation. Blob Detection block 62 performs post-processing to differentiate targets of interest. Blob Detection block 62 output is sent to Touch Tracking block 64 to track targets of interest as they appear in consecutive or proximal frames. Blob Detection block 62 output components can also be sent to a multi-chip interface 66 for multi-chip implementations. From the Touch Tracking block 64, results are sent to the Touch Data Physical Interface block 70 for short distance communication via QSPI/SPI.

In an embodiment, there is one DAC per channel. In an embodiment, each DAC has a signal emitter that emits a signal induced by the signal generator. In an embodiment, the signal emitter is driven by analog. In an embodiment, the signal emitter can be a common emitter. In an embodiment, signals are emitted by a signal generator, scheduled by the system scheduler, providing a list of digital values to the DAC. Each time the list of digital values is restarted, the emitted signal has the same initial phase.

The present systems and methods are described above with reference to block diagrams and operational illustrations of methods and devices for frame-phase synchronization in frequency division modulated touch systems. It is understood that each block of the block diagrams or operational illustrations, and combinations of blocks in the block diagrams or operational illustrations, may be implemented by means of analog or digital hardware and computer program instructions. Computer program instructions may be provided to a processor of a general purpose computer, special purpose computer, ASIC, or other programmable data processing apparatus, such that the instructions, which execute via a processor of a computer or other programmable data processing apparatus, implements the functions/acts specified in the block diagrams or operational block or blocks. Except as expressly limited by the discussion above, in some alternate implementations, the functions/acts noted in the blocks may occur out of the order noted in the operational illustrations. For example, and generally in FIG. 3, the order of execution if blocks shown in succession may in fact be executed concurrently or substantially concurrently or, where practical, any blocks may be executed in a different order with respect to the others, depending upon the functionality/acts involved.

While the invention has been particularly shown and described with reference to a preferred embodiment thereof, it will be understood by those skilled in the art that various changes in form and details may be made therein without departing from the spirit and scope of the invention.

What is claimed is:

1. A method for synchronizing frames with the phase of one or more simultaneously transmitted signals on a touch detector, the touch detector having a matrix comprising “N” rows and “M” columns of conductive material, the touch detector being arranged such that the paths of each of the “N” rows in the matrix crosses the path of each of the “M” columns in the matrix, the touch detector further comprising a receiver associated with at least one of the “M” columns, and at least one signal processor, the method comprising:
transmitting “N” signals, each of the “N” signals being transmitted on respective ones of the “N” rows of the matrix, each of the “N” signals being frequency-orthogonal to each of the other “N” signals, and each of the “N” signals being at a known initial phase;
capturing a first frame of signal from each of the “M” columns of the matrix, respectively, the step of capturing beginning at a predetermined time after the beginning of the transmitting step;
retransmitting the “N” signals, each of the “N” signals being transmitted on respective ones of the “N” rows of the matrix, the retransmission of each of the “N” signals being at the known initial phase; and
capturing a second frame of signal from each of the “M” columns of the matrix, respectively, the second capturing step beginning at a predetermined time after the beginning of the second transmitting step.

2. The method of claim 1, wherein the known initial phase for each of the “N” signals is predetermined, and may be the same as, or differ from the known initial phase of each other of the “N” signals.

3. An apparatus for synchronizing frames with the phase of one or more simultaneously transmitted signals on a touch detector, comprising:
row conductor and column conductor, arranged such that the path of the row conductor crosses the path of the column conductor;
clock having a predetermined periodicity,
signal emitter adapted to simultaneously initiate transmission on the row conductor, at each of a plurality of intervals on the clock starting at a first time, of a first and second orthogonal signal, each of the first and second orthogonal signals having a known initial phase;
receiver, adapted to start receiving a frame on the column at each of the plurality of intervals starting at a later time; and
signal processor adapted to determine a measure of each of the first and second orthogonal signals present within the received frame.

4. The apparatus according to claim 3, wherein the known initial phase for the first signal is the same as the known initial phase for the second signal.

5. The apparatus according to claim 3, wherein the known initial phase for the first signal is not the same as the known initial phase for the second signal.

6. The apparatus according to claim 3, wherein the known initial phase of the first and second orthogonal signals have a predetermined initial phase.

7. The apparatus according to claim 3, wherein the first and second orthogonal signals are frequency-orthogonal to each other.

8. An apparatus for synchronizing frames with the phase of one or more simultaneously transmitted signals on a touch detector, comprising:
first and second row conductors and column conductor, arranged such that the path of the first and second row conductors crosses the path of the column conductor;
clock having a predetermined periodicity,
first and second signal emitters adapted to simultaneously initiate transmission on the first and second row conductors, respectively, at each of a plurality of intervals on the clock starting at a first time, of a first and second orthogonal signal, each of the first and second orthogonal signals having a known initial phase;
receiver, adapted to start receiving a frame on the column at each of the plurality of intervals starting at a later time; and
signal processor adapted to determine a measure of each of the first and second orthogonal signals present within the received frame.

9. The apparatus according to claim 8, wherein the known initial phase for the first orthogonal signal is the same as the known initial phase for the second orthogonal signal.

10. The apparatus according to claim 8, wherein the known initial phase for the first orthogonal signal is not the same as the known initial phase for the second orthogonal signal.

11. The apparatus according to claim 8, wherein the first and second orthogonal signals have a predetermined initial phase.

12. The apparatus according to claim 8, wherein the first and second orthogonal signals are frequency-orthogonal to each other.

13. An apparatus for synchronizing frames with the phase of one or more simultaneously transmitted signals on a touch detector, comprising:
a matrix comprising “N” rows and “M” columns of conductive material, arranged such that the paths of each of the “N” rows in the matrix crosses the path of each of the “M” columns in the matrix;
clock having a predetermined periodicity,
“N” signal emitters adapted to simultaneously initiate transmission, at each of a plurality of intervals on the clock starting at a first time, of “N” signals,
each of the “N” signals being transmitted on a respective one of the “N” rows,
each of the “N” transmitted signals being orthogonal to each other of the “N” transmitted signals, and
each of the “N” transmitted signals having a predetermined initial phase;
receiver, adapted to start receiving a frame on the columns at each interval starting at a later time; and
signal processor adapted to determine a measure of each of the “N” signals present within the received frame.

14. The apparatus according to claim 13, wherein the signal processor and the receiver are part of the same component.

15. The apparatus according to claim 13, wherein the signal processor and the receiver are not part of the same component.

16. A method for determining measurements related to touch on a touch detector, the touch detector having a matrix comprising “N” rows and “M” columns of conductive material, arranged such that the path of the “N” rows in the matrix crosses the path of each of the “M” columns in the matrix, the touch detector further comprising a receiver associated with at least one of the “M” columns, the method comprising:
repeatedly:
1. initiating a transmission of “N” signals, each of the “N” signals being transmitted on respective ones of the “N” rows of the matrix, each of the “N” signals being frequency-orthogonal to each of the other “N” signals, and each of the “N” signals being at a known initial phase;
2. waiting a predetermined period of time after initiating the transmission, the predetermined period of time being at least sufficient for the “N” signals to charge the matrix;
3. receiving on the receiver a frame of signals present on each of the “M” columns of the matrix during a second predetermined period of time, the step of receiving beginning immediately after the predetermined period of time; and
for at least some of the received frames, determining a measure of the signals present on the “M” columns of the matrix during a time the corresponding frame was received.

17. The method of claim 16, wherein the known initial phase for each of the “N” signals is predetermined, and may be the same as, or differ from the known initial phase of each other of the “N” signals.

18. An apparatus for measuring a level of signals transmitted across a touch detector, comprising:
at least one row conductor and a column conductor, arranged such that the path of each of the at least one row conductors cross the path of the column conductor;
at least one signal emitter adapted to collectively transmit at least first and second orthogonal signals on the at least one row conductor, the first and second orthogonal signals having a beat frequency;
receiver, adapted to start receiving a frame on the column at an interval related to the beat frequency of the first and second orthogonal signals;
signal processor adapted to determine a measure of each of the first and second signals present within the received frame.

19. The apparatus according to claim 18, wherein the signal processor and the receiver are part of the same component.

20. The apparatus according to claim 18, wherein the signal processor and the receiver are not part of the same component.

21. The apparatus according to claim 18, wherein the interval is a multiple of the beat frequency of the first and second orthogonal signals.

22. The apparatus according to claim 18, wherein the at least one signal emitter is adapted to transmit the first and second orthogonal signals on one of the at least one row conductors.

23. The apparatus according to claim 18, wherein the at least one signal emitter comprises a first and second signal emitter, and the at least one row conductor comprises a first and second row conductor,
the first signal emitter being adapted to transmit the first orthogonal signal on the first row conductor, and
the second signal emitter being adapted to transmit the second orthogonal signal on the second row conductor.

24. An apparatus for measuring a level of a plurality of orthogonal signals in a touch detector, comprising:
matrix comprising rows and columns of conductive material, arranged such that the path of the matrix of rows and columns cross;
plurality of signal emitters, each of the plurality of signal emitters adapted to transmit one of a plurality of orthogonal signals onto a row of the matrix,
each of the plurality of orthogonal signals being orthogonal to each of the other of the plurality of orthogonal signals, and
the plurality of orthogonal signals having a beat frequency, the beat frequency having a periodic beat;
receiver adapted to start receiving a frame on one of the columns of the matrix at a time related to the periodic beat of the beat frequency;
signal processor adapted to determine a measure of each of the plurality of orthogonal signals present within the received frame.

25. The apparatus according to claim 24, wherein the signal processor and the receiver are part of the same component.

26. The apparatus according to claim 24, wherein the signal processor and the receiver are not part of the same component.

27. The apparatus according to claim 24, wherein the receiver is further adapted to receive a frame, periodically, at an interval related to the beat frequency of the plurality of orthogonal signals.

28. An apparatus for measuring a level of signals transmitted across conductors of a touch detector, comprising:
first row conductor, and a first column conductor, arranged such that the path of the first row conductor crosses the path of the first column conductor;
clock having a predetermined periodicity,
first signal emitter adapted to initiate a plurality of temporally separate transmissions of a signal having a known initial phase, each transmission of a signal starting at a time according to the clock;
receiver adapted to receive a frame from a column, the frame comprising at least a portion of one of the plurality of temporally separate transmissions, and adapted to start receiving the frame from the column at a later time according to the clock, the later time on the clock being after the corresponding transmission starting time; and
signal processor adapted to determine a measure of the first signal present within each received frame.

29. The apparatus according to claim 28, wherein the signal processor and the receiver are part of the same component.

30. The apparatus according to claim 28, wherein the signal processor and the receiver are not part of the same component.
